(19) United States
(12) Patent Application Publication
(10) Pub. No.: US 2003/0002429 A1
(43) Pub. Date: Jan. 2, 2003

(54) Optical information recording medium, stamper, and method of stamper manufacture

(75) Inventor: Seiji Morita, Yokohama (JP)

Correspondence Address: STAAS & HALSEY LLP, 700 11TH STREET, NW, SUITE 500, WASHINGTON, DC, 20001, US

(73) Assignee: Nikon Corporation of Tokyo, Japan

(21) Appl. No.: 10/180,092

(22) Filed: Jun. 27, 2002

(30) Foreign Application Priority Data
Jun. 29, 2001 (JP) 2001-197679

(51) Int. Cl. G11B 7/24

(52) U.S. Cl. 369/275.3

(57) ABSTRACT

An optical information recording medium, having information recorded along a track going from the inner circumference to the outer circumference, a lead-in region storing information relating to the recorded data contents of a program region, the program region where data is recorded, and a lead-out region which shows an end of the track, wherein the track pitch of the lead-out region is made narrower than the track pitch of the lead-in region and the program region.

### CROSS-REFERENCE TO RELATED APPLICATIONS

This application claims the benefit of Japanese Patent Application No. 2001-197679 filed on Jun. 29, 2001, the disclosure of which is incorporated herein by reference.

### BACKGROUND OF THE INVENTION

1. Field of the Invention

The present invention relates to optical disks, CD, CD-ROM and the like optical information recording media, stampers for their manufacture, and a method for manufacturing the stampers.

2. Description of the Related Art

Optical disks, magneto-optic disks, and the like optical information recording media have become widely used as data recording media and audio recording media. These optical recording media typically include a lead-in region, a program region, and a lead-out region. The program region typically stores data, e.g., user data. The lead-in region stores various information relating to the contents of the program region, for example, how much data or how many files are contained therein, where specifically these files are stored, or the length (time) of each file or data, etc. Lastly, the lead-out region, disposed outside of the program region, shows the termination of tracks formed in the optical information recording medium. When the tracking of the optical pickup, disposed in the recording device or playback device, deviates and overflows the program region, the lead-out region is used to return the tracking to the origin.

CD or CR-ROM are typically formed in a spiral manner, with minute concavities termed “embossed pits”, with a series of these concavities being referred to as a track. In order to position an optical pickup along the track, light reflected from the pits is detected by a push-pull method to help guide the optical pickup along the track.

In this manner, in an optical information recording medium, it is known to increase the information recording density by slowing the linear speed (m/s) and/or making the track pitch as narrow as possible when recording information. Moreover, if the program region can be made as wide as possible, it becomes possible to record additional information on the same sized information recording medium.

On the other hand, the resolving power of the optical pickup is determined by the wavelength of the light used and the numerical aperture (NA) of the optical system. By increasing the resolving power, by using a shorter wavelength and higher NA (λ=635-685 nm, NA=0.6) compared to the wavelength and numerical aperture normally used (λ=780 nm, NA=0.45), it becomes possible to use a smaller track pitch or a lower recording speed.

However, when simply making the track pitch narrower or slowing the linear speed, the embossed pits themselves become small, and it becomes impossible to play back recorded data unless a short wavelength, high NA, optical pickup is used. Consequently, by only simply narrowing the track pitch or slowing the linear speed, a problem arises in that no readout can be performed with a conventional optical pickup of λ=780 nm and NA=0.45. Namely, there is no interchangeability between the media recorded with the narrowed track pitch and slower linear speed and recording media used in the prior art. Thus a dedicated playback device, according to the recording technique, has to be used for each recording media.

High density recording of CD-R, CD-RW and the like recordable optical information recording media, has been discussed in Japanese Laid-Open Patent Publication JP-A-H10-222874 (hereinafter “JP-A-H10-222874”), which sets forth a means of making the track pitch and recording density in the lead-in region the same as in the prior art, thereby making it possible to recognize the disk even when using a prior art playback device. Nevertheless, even proceeding in this manner, when recording by making the track pitch or linear speed of the program region small without consideration, it is still the case that data recorded in this manner cannot be read out.

Furthermore, in JP-A-H10-222874, as shown in its embodiment examples, the track pitch or recording density is the same in the PCA region, PMA region, program region, and lead-out region, and only changes in the lead-in region. Because the PCA region is a region for a trial recording by the recording drive, and the PMA is a region to record the memory utilization state of the optical information recording medium, the concept taken from JP-A-H10-222874 is that recording and playback must be performed under the same conditions as in the program region.

As described above, a problem with the prior art is that a prior art optical pickup cannot be used to provide for an increase of recording capacity by simply making the track pitch or linear speed smaller. Another method which has been considered is the method of narrowing the track pitch as far as possible, and/or slowing the linear speed as far as possible, within a range in which the pits do not become smaller than the resolving power of the prior art pickups.

Nevertheless, even in the case that such a method is adopted, when the track pitch or linear speed is made small beyond a given limit, it became difficult for a playback device to recognize this optical information recording medium.

Normally, a playback device begins to move from about the start position of the lead-in region of the optical information recording medium, performs focusing, and recognizes the track of the optical information recording medium. However, when the lead-in region is narrow, the optical pickup is not able to find a focus, and the optical information recording medium cannot be recognized by this device.

Moreover, if the lead-in region is wide, as described in JP-A-H10-222874, it is possible to recognize the optical information recording medium, but when the track pitch or linear speed of the program region becomes very small in order to increase recording capacity, some optical pickups of the prior art still cannot play back the data recorded in the program region.

### SUMMARY OF THE INVENTION

To solve the above-described problems, an object of the present invention is to provide an optical information recording medium which, while using a playback device of the prior art, maximizes its performance, and moreover, an optical information recording medium with increased recording capacity which is also recognizable by the prior art recording devices or playback devices, an optical information recording medium which has interchangeability, a stamper for its manufacture, and the manufacturing method of this stamper.

Moreover, another object of the present invention is to provide for an optical information recording medium that can account for the case in which an increase in the recording capacity is provided for, i.e., the linear speed being made much smaller than in the prior art optical information recording medium, compared to prior art techniques where the optical information recording medium cannot be recognized by recording and playback devices.

Another object of the present invention is to provide a disk-shaped optical information recording medium with information recorded along a track, with the optical information recording medium having in sequence, from an inner circumference to an outer circumference, a lead-in region storing information relating to the recorded data contents of a program region, the program region where data is recorded, and a lead-out region which shows an end of the track, wherein the track pitch of the lead-out region is narrower than the track pitch of the lead-in region and the program region.

Since the lead-out region is not used for the data playback, there are no problems if a tracking error occurs to a greater or lesser degree, even if the embossed pits present in the lead-out region are not completely played back.

Therefore, the track pitch of the lead-out region can be made even more narrow than that which can be stably read out. The recording time of the lead-out region is set at, for example, 1 minute 30 seconds or more, but by making the track pitch narrower, the area occupied by the lead-out region on the disk can be made small, and because the portion of the recording medium that previously was occupied by the lead-out region is now available, the newly available portion can be added to the program region, thereby increasing recording capacity.

The track pitch of the program region could be between 1.2 μm and 1.3 μm, and accomplish the present object. The standard track pitch in an optical information recording medium for application in a prior art playback device, having an optical pickup of wavelength 780 nm, NA=0.45, is typically 1.5 μm-1.7 μm. The optical disk can track when the optical pickup is crossing a track by obtaining the peak-to-peak value of the obtained push-pull signal and determining when the peak-to-peak signal is greater than a predetermined ratio with respect to the magnitude of a signal obtained from a reflective portion with no pits.

Incidentally, the result of playing back with a prior art playback device is that a sufficiently large push-pull signal is obtained when the track pitch is 1.1 μm or more. Accordingly, tracking is typically possible if it is 1.1 μm or more, or more preferably 1.15 μm or more.

Moreover, so that the productivity of the optical information recording medium according to embodiments of the present invention is the same as for that of the prior art, the track pitch can be made greater, e.g., 1.2 μm or more.

Normally, CD or CD-ROM are molded in plastic resin, forming on this the corresponding shape of the embossed pits, with a reflecting film, etc. During the molding of this plastic substrate, a molding die is used having the reverse shape of the shape of the plastic substrate, and molding is performed by an injection molding method. Furthermore, when the track pitch becomes small, and the spacing from pit to pit becomes narrow, it becomes necessary to form a spatially dense configuration.

In an optical information recording medium having a normal track pitch, the time necessary for transfer of the shape of the molding die to the plastic resin is 6 seconds in the case of the normal track pitch. Accordingly, it has been found that in the smallest track pitch which could be formed by injection molding, with a track pitch of 1.2 μm or more, the molding time came within the standard time of 6 seconds. Accordingly, because high productivity is maintained, it is possible to mass-produce optical information recording media according to embodiments of the present invention having increased recording capacity.

Moreover, if the upper limit of the track pitch of the program region is less than 1.5 μm, an increased density becomes possible. Nevertheless, in order to obtain complete interchangeability, even in one in which tracking is applied with a scarce three-beam type, the upper limit of track pitch can be made to be less than 1.3 μm, so that tracking becomes possible. At a value greater than this, pits formed in adjacent tracks can be received by a subspot which detects tracking error. Therefore, this value can be set such that a subspot does not read the center of an adjacent track. Furthermore, actually, because nearly all playback devices are of the one-beam type, it typically does not matter if there is no conformity with this upper limit.

Another object of the present invention there is provided an optical information recording medium where the amount of eccentricity is 30 μm or less. Accordingly, this 30 μm result was experimentally found for the amount of eccentricity, wherein even if the track pitch is made narrow, tracking with a playback device is easy.

Another object of the present invention is to provide an optical, information recording medium, wherein the linear speed of the program region is made 1.0 m/s or more. Using a prior art playback device, with a wavelength 780 nm (NA=0.45), the smallest linear speed to resolve the smallest mark by a playback device was found to be 0.90 m/s or more. Furthermore, the smallest linear speed necessary in order to obtain a sufficient value with this prior art playback device for the degree of modulation of a 3T mark or an 11T mark was also found. As a result, it was found that if the linear speed was 1.0 m/s or more, playback was possible from the present optical information recording medium, with the signal being stabilized when reading and recording.

Another object of the present invention is to provide an optical information recording medium, having information recorded along a track going from the inner circumference to the outer circumference, a lead-in region storing information relating to the recorded data contents of a program region, the program region where data is recorded, and a lead-out region which shows an end of the track, wherein the linear speed of the lead-out region is made slower than the linear speed of the lead-in region and the program region. A further object of the present invention is to provide this optical information recording medium with the track pitch of the lead-out region narrower than the track pitch of the lead-in region and the program region.

By making the track pitch small and the linear speed small, the area necessary for the lead-out region can be made still smaller, and the recording capacity can be enlarged without changing the size of the optical information recording medium. The track pitch of the program region can be between 1.2 μm and 1.3, thereby increasing productivity and recording capacity of the program region. Since the memory capacity per unit area is large and because the price can also be kept low, a high density optical information recording medium of the present invention is therefore more desirable. Another object of the present invention is to provide this optical information recording medium with an amount of eccentricity of each groove or land of 30 μm or less, thereby allowing the recording capacity to become large and the tracking easily attained. A further object of the present invention is to provide this optical information recording medium with the linear speed of the program region being 1.0 m/s or more. Therefore, while increasing the recording capacity of the program region, the recording and playback of the program region becomes more reliable, and a highly interchangeable optical information recording medium is obtained.

Another object of the present invention is to provide an optical information recording medium with a diameter of 80 mm and a maximum recording time between 30 minutes and 40 minutes. When the diameter of the optical information recording medium is 80 mm, the program region is formed in this manner, the utility value of the optical information recording medium is increased and it becomes possible to use the optical information recording meidum as recording media in a small-size portable device or audio recording device.

Furthermore, in the case of an optical information recording medium recordable for 30 minutes as digital audio, the recording medium may record 265 MB as digital information under the ISO 19660 Model 1 Format, which is a CD standard. In this manner, the lower limit of the recording time may be limited to 30 minutes, and not above this in an 80 mm disk, so that six songs can be reliably recorded.

Furthermore, when the recording time becomes longer than 40 minutes and the track pitch or the linear speed of the program area are made too small, in an optical information recording medium of 80 mm diameter, tracking becomes impossible, or the pits do not obtain a sufficient degree of variation, with the result that jitter becomes large, and playback tends to become impossible. Therefore, 40 minutes or less may be preferable.

Another object of the present invention is to provide a disk-shaped optical information recording medium, with information recorded along a track going from the inner circumference to the outer circumference, and having, a lead-in region storing information relating to the recorded data contents of a program region, the program region where data is recorded, and a lead-out region which shows an end of the track, wherein the track pitch of the program region is between 1.2 μm and 1.3 μm, and the linear speed of the program region is between 1.0 m/s and 1.13 m/s.

According to this object, the optical information recording medium can be played back with an optical pickup of the prior art. In addition, to maintain the maximum recording time to 34 minutes or slightly more, in an 80 mm CD, the maximum value of the linear speed can be set at 1.13 μm.

Another object of the present invention is to provide a disk-shaped optical information recording medium, with information recorded along a track going from the inner circumference to the outer circumference, and having, a lead-in region storing information relating to the recorded data contents of a program region, the program region where data is recorded, and a lead-out region which shows an end of the track, wherein the track pitch of the program region is made narrower than the track pitch of the lead-in region.

Initially, since the lead-in region is read out by a playback device, it is necessary for focusing of the optical pickup to be easily performed on the lead-in region. Therefore, it is better for the track pitch to be wide. On the other hand, once the optical pickup is focused, the optical pickup focuses easily even if focusing conditions are more difficult. Thereupon, by adopting a wide track pitch for the lead-in region as in a prior art CD, to design for an increased recording capacity, recognition of the medium is easily performed on insertion of the optical information recording medium into the prior art playback device. Thus, an optical information recording medium having high recording capacity can also be obtained, by narrowing the track pitch of the program region.

Another object of the present invention is to provide a disk-shaped optical information recording medium, with information recorded along a track going from the inner circumference to the outer circumference, and having, a lead-in region storing information relating to the recorded data contents of a program region, the program region where data is recorded, and a lead-out region which shows an end of the track, wherein a linear speed of the program region is made slow in comparison with a linear speed of the lead-in region.

In order for this optical information recording medium to be easily recognized when inserted into the prior art playback device, the linear speed of the lead-in region was made large, similar to a prior art CD. Therefore, the embossed pits formed in the lead-in region become comparatively large, and it becomes easy for the optical pickup to recognize the embossed pits. On the other hand, in the program region, because complete compensation is possible by means of existing error correction technology, even if there are readout errors of more or fewer of the embossed pits, the recording capacity is increased by use of a low linear speed of this portion. Another object of the present invention is to provide this optical information recording medium using a stamper that has concavities corresponding to the convexities, and convexities corresponding to the concavities, formed in the optical information recording medium. Still another object of the present invention is to provide this optical information recording medium, wherein the optical information recording medium can be manufactured with good efficiency. A further object of the present invention is to provide this optical information recording medium, wherein the eccentricity of the concavities or convexities is made 10 μm or less.

In this manner, with an eccentricity of the concavities or convexities of the stamper being 10 μm or less, it is possible for the eccentricity of the track of the optical information recording medium formed by this stamper to be 30 μm or less. A further object of the present invention is to provide this optical information recording medium, wherein a first molding die is made of metal, and by implementing a process of molding from the first molding die a second molding die made of resin, and a process of molding from the second molding die a stamper made of metal which is a third molding die.

Accordingly, in an electrocasting method or metal film forming method or the like, a first molding die can be manufactured which is a stamper that can be used to manufacture an optical information recording medium. Then, an optical information recording medium may not be directly manufactured with this first molding die, as this first molding die molds a second molding die made of resin, with concavities and convexities of the first molding die reversed, by taking an impression and pressing this first molding die to the resin.

After this, using this second molding die, a stamper made of metal is made using a process similar to the process which structured the first molding die. An optical information recording medium can thus be manufactured by not directly using the first stamper molding die, but rather by manufacturing plural second molding dies, used as stampers, to generate an additional molded stamper made of metal as the third molding die, so that plural stampers can be made by a simple process, even without the multiple use of lithographic methods.

Additional objects and advantages of the invention will be set forth in part in the description which follows and, in part, will be obvious from the description, or may be learned by practice of the invention.

### BRIEF DESCRIPTION OF THE DRAWINGS

These and other objects and advantages of the present invention will become apparent and more readily appreciated from the following description of the embodiments, taken in conjunction with the accompanying drawings of which:

FIG. 1A is a diagram showing an arrangement of recording regions of an optical information recording media;

FIG. 1B is a diagram showing a track pitch or linear speech in each region of an optical information recording media;

FIGS. 1C-1D are diagrams showing track pitch or linear speed in each region of an optical information recording media for first through third embodiments of the present invention;

FIG. 2A is another diagram showing an arrangement of recording regions of an optical information recording media;

FIG. 2B is a diagram showing track pitch and linear speed in each region of an optical information recording medium for a fourth embodiment of the present invention;

FIG. 3A is another diagram showing an arrangement of recording regions of an optical information recording media;

FIG. 3B is another diagram showing a track pitch or linear speech in each region of an optical information recording media;

FIGS. 3C-3D are diagrams showing track pitch and linear speed in each region in an optical information recording media for the first through third embodiments of the present invention;

FIG. 4A is another diagram showing an arrangement of recording regions of an optical information recording media;

FIG. 4B is a diagram showing track pitch and linear speed in each region in an optical information recording medium for the fourth embodiment of the present invention; and

FIG. 5 is a diagram showing a method of manufacture of a stamper for an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

Furthermore, the following embodiments are described for the case of playback devices using optical pickups of wavelength 780 nm, and numerical aperture 0.45, which are those mostly in use at the present time. However, the present invention is not limited thereto, and in this manner the present invention is not limited to the media which are used only in such playback devices. The invention can be applied to media for use in playback devices of different wavelength or numerical aperture and accordingly different resolving power. Further, it is also possible to use the present invention using standards associated with such playback devices.

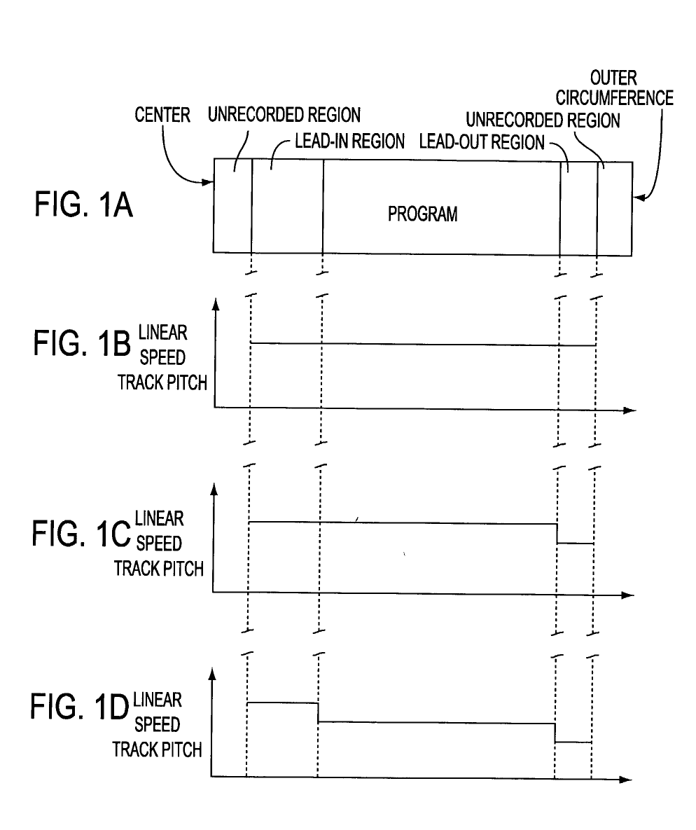

In a first embodiment, the optical information recording medium is a compact disk (CD hereinafter), and, as illustrated in FIG. 1A, is formed from the inner circumference to the outer circumference with a lead-in region, a program region, and a lead-out region, respectively formed on a continuous track. In the lead-in region, a Table of Contents (TOC), or sector header and the like supplementary information are recorded. Furthermore, the TOC record contains at least the track information, which includes the start sector of each track, and the respective sector header in the start region of each sector. This sector header contains sector sync, sector address, error detection symbols, and subcodes, and can use error correction coded information by means of long distance codes of 8 parity symbols and more as record information.

Furthermore, in the first embodiment, the CD has embossed pits arranged on respective tracks. Normally, in the revolution time of the optical information recording medium, the linear speed is about 1.2-1.3 ms, with the linear density of the embossed pits being set such that the carrier frequency becomes 44.1 kHz. The pitch is made to be 1.5 μm or more in the track in which the embossed pits are formed. However, in the lead-out region the linear speed or track pitch can be made small.

Moreover, the start radius of the lead-in region and the start radius of the program region, are set in predetermined positions so as to comply with the Red Book standards or Yellow Book standards or ISO/IEC 10149 or JIS X 6281. That is, because the interval from the lead-in region start time to the program region start time is also set as a standard, the linear speed or track pitch of the lead-in region cannot vary from this restriction. Nevertheless, regarding the lead-out region, there is no restriction other than that set by the standard of the recording time being 1 minute and 30 seconds.

Accordingly, the CD of this embodiment, so that it sufficiently satisfies such standards, was made with a track pitch of the lead-in region, similar to the prior art, e.g., of 1.5-1.7 μm. Moreover, the linear speed was made to be about 1.2 m/s. In this manner, it has sufficient interchangeability with playback devices from the prior art.

In the CD of this embodiment, the arrangement of each region and the track pitch in each region are shown in FIG. 1A. FIG. 1A shows the arrangement of each region of the optical information recording medium, including, from the center: a non-recording region having no pits, a lead-in region, a program region, a lead-out region, and another non-recording region having no pits.

FIGS. 1B-1D are diagrams showing the track pitch or linear speed corresponding to each of the regions. FIG. 1B corresponds to a prior art compact disk (hereinafter, “CD”), where track pitch and linear speed are constant in the lead-in region, program region, and lead-out region.

FIG. 1C corresponds to the CD the first embodiment, where the track pitch and linear speed in the lead-in region and program region are constant, because information recorded in these regions is such as to be reliably written and read out, with a linear density of a sufficiently large track pitch and a sufficiently small embossed pits. On the other hand, in the lead-out region, by making the track pitch of the lead-out region small, within a range that satisfies only the standard of recording time of the lead-out region, the area occupied by the lead-out region can be reduced.

The portion of area which is no longer needed for the lead-out region can now be allocated to the program region to increase the recording capacity of the program region.

Next, the optical information recording medium in the second embodiment of the present invention will be described.

In this second embodiment, the optical information recording medium is a CD similar to the first embodiment. In the CD in the second embodiment, the linear speed is made small instead of the track pitch being made small. Specifically, the linear speed of the lead-in region and program region is made the same as the linear speed of an optical information recording medium from the prior art, while in the lead-out region the linear speed is made smaller than in the lead-in region and the program region. Therefore, with the recording density of the lead-out region being high, the area necessary to obtain the recording time of 1 minute 30 seconds or more set in the standard can be saved. Moreover, by allocating a portion of the saved area of the lead-out region to the program region, the recording capacity of the program region can be made large.

Furthermore, the reason why the linear speed in the lead-in region is made large in comparison with that in the lead-out region is as follows.

In some playback devices of the prior art, in order to recognize a CD, focusing and tracking control is performed. Furthermore, in the playback device, the rotational linear speed of the CD is controlled so that the subcode signal can be acquired and synchronized within a predetermined time. In a prior art CD, the linear speed is 1.2-1.3 m/s, and the carrier frequency is 44.1 kHz. Unrelated to the kind of CD, the playback device then drives the CD at the normal rotation speed.

If the carrier frequency of the signal obtained from the optical pickup is then higher than 44.1 kHz, a control circuit may be able to control the rotation of the CD up to a sufficiently high frequency to pull in a signal up to a sufficiently high frequency. However, it is not known how high of a frequency that can be pulled in by a playback device, and accordingly there are cases where the control system of the playback device cannot respond to the signal frequency obtained from the optical pickup.

Therefore, in a CD of this second embodiment, in order to be adapted to a playback device, the CD was made so that the linear speed in each portion of the lead-in region is of the same degree as that of the prior art CDs.

Furthermore, in a CD of this second embodiment, or in the master disk used to manufacture this CD, when making the linear speed small, it becomes possible to make the linear density of the embossed pits high. Furthermore, the distribution of linear speed corresponding to each region is as shown in FIG. 1C, with the ordinate being considered the linear speed.

Next, a description is given of the optical information recording medium in a third embodiment. In the third embodiment, the optical information recording medium is also assumed to be a CD as in the previous embodiment. This optical information recording medium, compared to the CD in the first embodiment, has a narrowed track pitch in the program region. By making the track pitch in the program region narrow in this manner, a further increase of recording density can be generated. The distribution of track pitch in each respective region is shown in FIG. 1D.

In the optical information recording medium in this third embodiment, the track pitch of the program region was made narrow, though it was found that there was a risk of tracking becoming impossible with a prior art optical pickup having a wavelength of 780 nm and a numerical aperture of 0.45 when the track pitch was made too narrow. For this reason, by setting the track pitch in a particular range, use was possible in a playback device, and it became possible to obtain an optical information recording medium of enlarged recording capacity.

The particular range included the lowest limiting necessary track pitch in the program region being 1.1 μm. If the track pitch is wider than this, the push-pull signal necessary for tracking control is obtained, even in prior art playback devices. Furthermore, preferably if the track pitch is 1.15 μm or more a large enough push-pull signal can be obtained.

When the track pitch is too narrow, productivity is low when manufacturing the CDs. Therefore, if the track pitch is wider than 1.2 μm, they are about equal in cost to prior CDs.

Normally, in the conventional manufacture of CDs, a stamper is used having a corresponding form of embossed pits. This stamper is a molding die forming the shape of the embossed pits in a plastic substrate. The plastic substrate used in the CD is molded by an injection molding process using the stamper. The CD is further manufactured by film forming a reflecting film on the molded plastic substrate.

When molding this plastic substrate, the plastic resin is caused to sufficiently penetrate into the rough surface of the stamper, time is then necessary for cooling and solidification. This time is 6 seconds for the conventional CDs. Other processes to manufacture the CD can be set so as to be simultaneous with this time. In this manner, conventional CDs can be manufactured at low cost.

In the third embodiment of the present invention, compared to an embodiment having minute embedded pits as an optical information recording medium, in order to mold embossed pits having a quality similar to the former CDs, time has to be spent in the process of molding the plastic substrate. Furthermore, shortening the time for sufficient penetration into the rough surface of the stamper is possible by increasing the temperature of the molding die, or by a technique which increases the mold closing force. However, when the former technique is adopted, cooling time becomes long. Moreover, when the latter technique is adopted, the mold closing device itself has to be changed, which entails high costs.

The present inventors therefore investigated the track pitch in order for 6 seconds to become possible in the conventional plastic substrate molding process, with the result being that a track pitch of 1.2 μm or more was found to generate no problems.

Moreover, if the upper limiting value of the track pitch of the program region is 1.5 μm or less, a higher density becomes possible. Furthermore, by this technique, in order to have complete interchangeability, investigations were also accumulated on the application of tracking by use of a three-beam technique. The condition under which it is possible to apply the three-beam technique was to satisfy an upper limiting value of the track pitch of less than 1.3 μm. At a track pitch between 1.3 μm and 1.5 μm, the subspot which detects the tracking error then received a large effect from a pit formed in an adjacent track. Consequently, this value was set so that the subspot does not read the center of an adjacent track.

In this manner, with a track pitch of 1.2 μm or more, tracking became possible using an optical pickup using a wavelength of 780 nm, with a numerical aperture of 0.45. Moreover, particularly by use of the three-spot method, the track pitch may be set to between 1.3 μm and 1.5 μm, and by setting the track pitch smaller than 1.5 μm in the program region, an optical information recording medium can be obtained with a further increased recording capacity.

Furthermore, other than the method of increasing the recording capacity by making the track pitch of the program region small, a similar effect can also be obtained by making the linear speed smaller.

In this case, it was found to be preferable to set the linear speed in the program region within the following range. The minimum linear speed for resolution was found, under which a minimum embossed pit can be resolved by use of a prior art playback device of wavelength 780 nm (NA=0.45) to be 0.90 m/s or less. Furthermore, the minimum linear speed was found by using a degree of modulation of a 3T mark (13 hereinafter), or the degree of modulation of an 11T mark (I11 hereinafter). As a result, it was found that, if the linear speed was 1.0 m/s or more, playback was possible from an optical information recording medium, of a signal stabilized when reading and recording. At this speed, I3 or I11 settled in the range of 0.3-0.6, and jitter also became less than 35 ns, with the average value of block error rate becoming 50 or less per second. This result is thought to occur because of the rotation speed of a motor is capable of stabilized rotation lower than the lower limiting value, particularly when recording or playing back outside of the program region. Accordingly, if the linear speed is 1.0 m/s or more, the stabilized rotation control of the medium becomes possible because the jitter or degree of modulation of the playback signal becomes good. Therefore, the use of the optical information recording medium of the present invention becomes possible even in a conventional playback device.

Moreover, not only can either of the track pitch or the linear speed be made smaller in the program region, but both the track pitch and linear speed can also be made smaller in the program region, thereby increasing the recording capacity of the optical information recording medium. Furthermore, the optimum track pitch and linear speed in the program region, for the reasons given hereinabove, are preferably between 1.2 and 1.3 μm and preferably 1.0 m/s or more, respectfully. Furthermore, the upper limit value of linear speed, in order to add useful commercial value to an 80 mm CD, may be 1.13 m/s or less. If it is 1.13 m/s, it becomes possible to make the recording time 34 minutes or more in a CD of 80 mm diameter, and it is even possible to increase the recording time 11 percent with respect to a conventional CD. Incidentally, the format at this time, is recorded at the CD digital audio format (standardized frequency 44.1 kHz, quantization number 16 bit, 2 channels (right and left)).

In the case of an 80 mm CD, because a track pitch or linear speed for such a sized CD is difficult to reproduce having more than 40 minutes, it is preferable to have the CD made with 40 minutes or less of capacity.

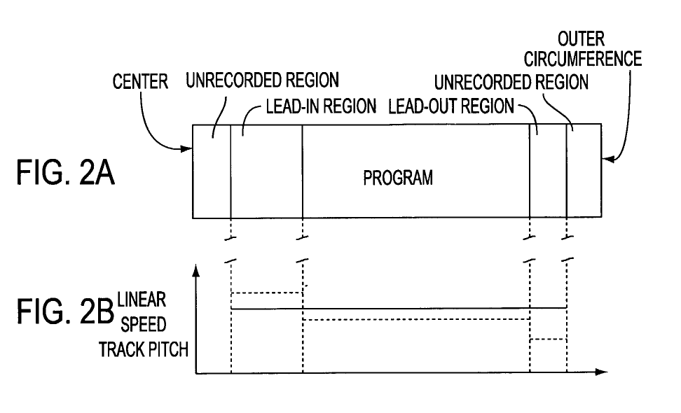

As mentioned hereinabove, by making the track pitch or linear speed in the lead-out region smaller than in the lead-in region, it is possible to increase the recording capacity in the program region, but more preferably, it is better for the linear speed to be the same in the lead-in region, program region, and lead-out region. In an optical information recording medium according to a fourth embodiment of the present invention, only the track pitch is suitably changed, and by fixing the linear speed for any region as a constant, stabilized tracking is possible. Furthermore, the optical information recording medium is a CD in the fourth embodiment as, illustrated in FIG. 2A.

When the playback device plays a CD, the rotation speed of the motor used to rotate the CD of the playback device, is controlled according to the linear density of the embossed pits. Because of the responsibility falling on the motor of the playback device that rotates the CD, it is preferable to make the linear speed the same along the lead-in region, program region, and lead-out region. Instead, the track pitch of the lead-in region can be placed to a setting allowing recording and playback, with the track pitch of the lead-out region being set to a marginally smaller track pitch, the recording capacity can increase. Moreover, by suitably setting the program region in a track pitch range mentioned hereinabove, a further increase in recording capacity can be expected.

In the fourth embodiment, the distribution of track pitch and linear speed in each region of the optical information recording medium is shown in FIG. 2B. Furthermore, the solid line of FIG. 2B shows linear speed, and the dotted line of FIG. 2B shows track pitch.

Furthermore, in the case that the track pitch in the program region is between 1.2 μm and 1.3 μm, the width of the portion in which embossed pits are formed is preferably between 300 nm and 550 nm. A lower limit of 300 nm or more, with wavelength λ=750 nm and numerical aperture NA=0.45, is the width in which the optical pickup can resolve the presence or absence of the pits.

If the track pitch of the program region is made narrow, the effects due to eccentricity in the medium also become large. Because of this, if the program region is made narrow in the abovementioned range, it is preferable to make the eccentricity 30 μm or less.

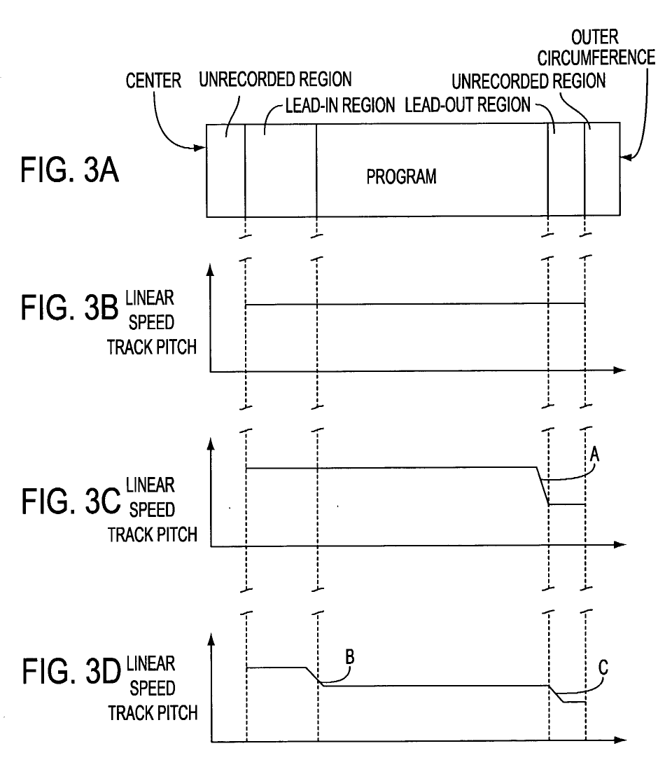

FIGS. 3A-3D show another diagram of the first through third embodiments, with FIG. 3A showing the sequential arrangements of regions in the CD similarly to FIG. 1A, and with FIG. 3B corresponding similarly to FIG. 1B.

In the first through fourth embodiments, there is a change in at least the track pitch or linear speed in the lead-out region. Nevertheless, when the track pitch abruptly changes in this manner, following of the tracking becomes difficult and, if anything, there is a possibility of the light spot coming out of the track. On the other hand, when the linear speed abruptly changes, a large burden is placed on the control circuit that rotationally drives the optical information recording medium, and the playback device may become unable to follow with respect to the linear speed demanded by the optical information recording medium, thereby subsiding into the result that the playback signal cannot be obtained.

In order to avoid such circumstances, in the first through third embodiments, the change of linear speed or track pitch, as shown in FIG. 3C, it is better to arrange for the track pitch or linear speed to gradually change, as arranged in the transition region A. Regarding the optical information recording medium in the first and second embodiments, the distribution of track pitch or linear speed of each respective region is as shown in FIG. 3C. In this manner, the transition region A is disposed near the boundary of the program region and lead-out region. In the first embodiment, the track pitch gradually becomes smaller in the transition region A. In the second embodiment, the linear speed gradually becomes smaller in the transition region A. In this manner, the following of the tracking of the playback device becomes smooth, moreover the rotation control system of the CD also stabilizes and can perform linear speed control.

Moreover, in the third embodiment, regarding the optical information recording medium, as shown in FIG. 3D, it is preferable to form a transition region B in the boundary portion of the lead-in region and the program region, and a transition region C close to the boundary of the program region and the lead-out region. In these portions where the track pitch and linear speed respectively change, it is preferable to dispose the transition regions so that the track pitch or linear speed change gradually.

Furthermore, it is preferable to dispose the transition region in the end portion of the lead-in region. The reason for this is that in the lead-in region, for a predetermined time, the same repeating information is recorded until the data is covered. Therefore, by disposing the transition region in this portion, the track pitch or linear speed are made to gradually change. In this manner, control of the playback device becomes easy, and even if changes occur in the various controls of the playback device, the effect on the playback signal would be small.

On the other hand, the transition region between the program region and the lead-out region is preferably in the lead-out region. This is because the lead-out region can show the end of the track well, and it is not necessary to accurately read out the embossed pits.

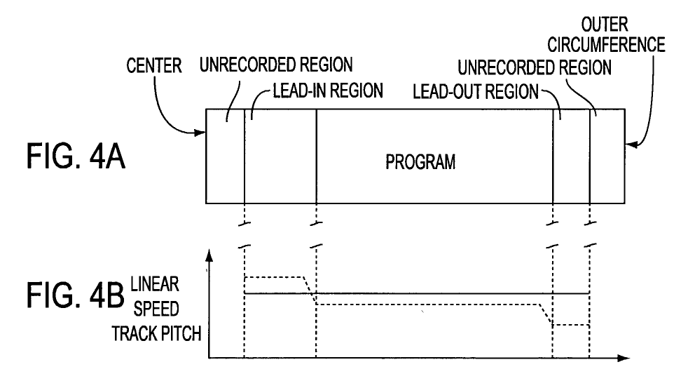

Furthermore, as the optical information recording medium in the previously described fourth embodiment, with a fixed linear speed with only the track pitch being caused to change in portions of the program region and lead-out region, it is preferable to maintain the linear speed and track pitch in each respective region, as shown in FIG. 4B. FIG. 4A is the same as FIG. 1A. Because the transition regions as shown in FIG. 4B are in the respective lead-in region end portion and lead-out region, as aforementioned, the probability is low for bad effects on the playback signal.

By setting the track pitch between 1.2 μm and 1.3 μm, and the linear speed between 1.0 and 1.13 μm without varying the track pitch and the linear speed in the CD, it is possible to read data recorded on the CD with a playback device, based on compact disk standards, resulting in a higher recording capacity than with a prior art compact disk.

Incidentally, in a playback device having wavelength λ=780 nm, and a numerical aperture NA=0.45, if the track pitch is 1.1 μm or more, the peak-to-peak value (push-pull signal) obtained when passing across a track, comparison with the signal obtained from a reflecting signal with no pits, can obtain a sufficient degree of tracking. Furthermore, a track pitch of 1.15 μm or more is preferred.

Accordingly, if the track pitch is 1.1. μm or more (preferably 1.15 μm or more), because tracking is possible, tentatively recording and playback becomes possible. Nevertheless, as described hereinabove, the productivity of compact disks including CD is reduced. Consequently, the commercial value of low cost CD decreases. Accordingly, to obtain the same productivity as with the prior art CD and also to attain high density recording, it was found that a track pitch of 1.2 μm or more is preferable.

Moreover, according to the preferred embodiments, of the present invention, the track pitch is preferably made less than 1.3 μm. The reason for this is also described in conjunction with the first embodiment of the invention. Thereby, tracking is possible even in using the present small 3 beam method.

Moreover, a linear speed of 1.0 m/s or more is preferable. In a track pitch of less than 1.0 μm, with a recording and playback device having an optical detector of wavelength λ=780 nm, and a numerical aperture NA=0.45, if the track pitch is 0.90 μm or more, the minimum mark does not become smaller than the resolution of the optical detector.

Accordingly, it is possible to read out a minimum mark with a prior art playback device, but in the present invention, the minimum linear speed was found, accepting the range of 0.3-0.6 for I3 or I11, such that jitter becomes 35 ns or less and the average value of the block error rate is less than 50 per speed. Thereby, playback was found to be possible with a liner speed of 1.0 m/s. This is because, when the linear speed is too low, the linear speed becomes lower than the lower limit value of the rotation speed of a motor capable of stable rotation in recording or playback, particularly outside of the program region.

Accordingly, in a CD, if the linear speed is 1.0 m/s, it is considered that, because the rotation speed of the motor can rotate stably at a rotation speed outside of the program region, it is tolerable that jitter and the like properties do not decrease.

Next, it is preferable to make the upper limit value of the linear speed 1.13 m/s or less. Thereby, it is possible to get a higher recording capacity than the capacity of a prior art CD.

Furthermore, the solid line in FIG. 4B shows the linear speed, and the dotted line shows the track pitch.

Incidentally, an optical information recording medium of this kind, as aforementioned, is based on the master disk, and thereby forms the desired embossed pits. In the case of manufacturing the master disk, by a laser cutting machine, etc., processing is performed, corresponding to the embossed pits, by moving the table in a process machine, on which the master disk is fixed, and by causing the laser, etc., processing tool to move in a pickup movement manner. When causing the track pitch to change, the response speed and the following accuracy of the pickup movement method are better, but from the aspect of the process accuracy of the whole disk, the table movement method is superior; it is preferred to know how to suitably use both properly.

Furthermore, in order to form the track pitch with high accuracy, in the case of applying the table movement method, a drive circuit causes driving of the table in a conventional manner. More specifically, while performing position determination in the position in the radial direction of the master disk, a control step becomes necessary for the formation of the track.

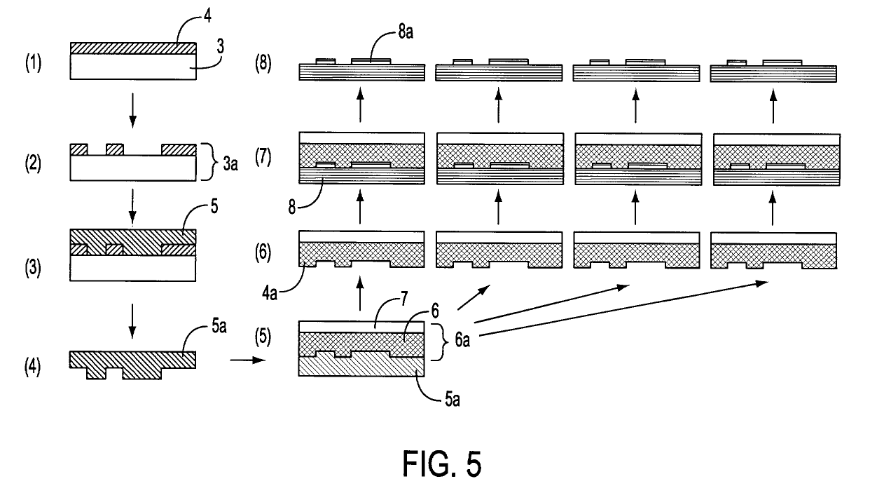

Next, the method of manufacture of the stamper which can be applied to the optical information recording medium of the first through fourth embodiments of the present invention is shown in FIG. 5, and is further described below.

Green plate glass as a substrate material is processed into a donut-shaped disk, as the substrate 3. After this, the surface of the disk is precision polished to a surface roughness Ra=1 nm or less. After washing, a primer and photoresist 4 are successively spin coated. When pre-baking, a photoresist layer 4 of about 200 nm thickness is formed on the respective substrate 3, operation (1) in FIG. 5.

Next, using a laser cutting machine, the photoresist 4 on the substrate 3 is exposed, operation (2) in FIG. 5. The exposure pattern is used as the pattern according to the track pitch of the optical information recording medium to which the present invention relates.

The resist 4 on the exposed substrate 3 is exposed with a respective inorganic alkali developing solution. The resist surface is spin washed, and after this, is post-baked. The resist pattern is thereby formed.

Next, setting this master disk 3a in a sputtering machine, a nickel layer 5 (electrically conductive layer) is adhesively deposited. By this step, the treatment to form electrical conductivity ends. Then, by conducting electricity, Ni electrocasting is performed, and a Ni plating layer 5 of predetermined thickness is obtained, operation (3) in FIG. 5. Then, when this Ni plating layer 5 is peeled off from the master disk 3a, a first molding die 5a is obtained, operation (4) in FIG. 5.

A protective coating (one example: trade name, Clean Coat S (Fine Chemical Japan Co.)) is coated by a spin coating method onto the rough surface of the first molding die 5a. The coating is allowed to dry naturally. The rough surface is thereby covered with a protective coat. After the reverse surface of the first molding die 5a has been polished, its internal diameter and external diameter are punched out. In this manner, the first molding die 5a is prepared.

The master disk 3a is undamaged after the first molding die 5a has been separated. Therefore, after the master disk 3a has been washed, again performing this process, plural first molding dies 5a can be obtained. When a stainless steel base has been adhered to the reverse surface of the first molding die with epoxy adhesive, the flatness of the first molding die 5a is improved.

Next, an ultraviolet ray hardening resin solution is prepared. As the resin solution, heat or light absorption characteristics, mold release, light resistance, durability, and hardness are considered, color number (APHA) 30-50, refractive index at 25° C. 1.4-1.8 are preferred. From the viewpoint of transferability, preferably the specific gravity of the resin solution is about 0.8-1.3 at 25° C., and the viscosity at 25° C. is preferably about 10-4,800 cps.

Separately, a green glass disk 7 is prepared. Then, washing the disk, a primer which is a silane coupling agent is coated on, and after this, baked. Then, with the rough surface of the first molding die 5a upward, the resin solution 6 is dropped. The glass plate 7 is then pressed on from above, and the resin solution 6 is sandwiched between the glass plate 7 and the first molding die 5a. At this time, care is taken that no bubbles enter the resin solution 6. Further pressing on the glass disk 7, the viscous resin solution 6 is pressed out uniformly on the whole surface of the first molding die 5a.

Ultraviolet rays are irradiated from a mercury lamp through the glass plate 7 onto the resin solution 6. Hardening the resin solution by this methodology, a second molding die 6a is formed from the hard resin layer 4a, operation (5) FIG. 5. Next, the second molding die 6a is separated from the first molding die 5a. The second molding die 6a includes an integral structure with the glass plate 7, operation (6) FIG. 5.

The remaining first molding die 5a, after having been separated, is undamaged and can be repeatedly re-used. Therefore, plural second molding dies 6a can be molded from one first molding die 5a. The manufacture of the second molding dies is easy, and one can be manufactured in 15-60 minutes.

Next, with the second molding die 6a as the origin, a third molding die is formed from metal. The method of manufacture is the same as the method of manufacture of the first molding die 5a. Namely, the second molding die 6 is set in a sputtering device, and a Ni layer 8 (electrically conductive layer) is caused to adhere and deposit on the surface. This ends the treatment for providing electrical conductivity. Then, performing electrocasting by the passage of electric current, a Ni plating layer 8 of predetermined thickness is obtained, operation (7) FIG. 5. Then, this Ni plating layer 8 is separated from the second molding die 6a, and the third molding die 8a is obtained, operation (8) FIG. 5.

A protective coating (one example: trade name, Clean Coat S (Fine Chemical Shapan Co.)) is coated by a spin coating method onto the rough surface of the third molding die 8a by a spin coating method. The coating is allowed to dry naturally. The rough surface is covered with a protective coat by this means. After the reverse surface of the third molding die 8a has been polished, its internal diameter and external diameter are punched out. In this manner, the third molding die 8a is prepared. After the reverse surface of the third molding die 8a has been polished, its internal diameter and external diameter are punched out. In this manner, the third molding die 8a is prepared. This third molding die is actually used, as a stamper, for the manufacture of disks.

Furthermore, the present inventors, using such a manufacturing method, manufactured optical information recording media with varied track pitch and linear speed of the program region, as brought together in the embodiment examples, with the following results.

As mentioned hereinabove, in the case of an optical information recording medium with the track pitch made narrow in the program region, the eccentricity was 30 μm or less, but in order to satisfy this eccentricity, from the present inventors' experience it was found that the eccentricity of the track constituted by the embossed pits was 10 μm or less. Next, embodiment examples relating to the present invention are illustrated below.

### EXAMPLE 1

An optical disk according to this example (compact disk, hereinafter “CD”) was manufactured. The size of the optical disk is 80 mm. Firstly, a stamper according to an embodiment of the invention was manufactured.

Lead-in region start time was 97:27:00, program region start time was 00:00:00, lead-out region start time (last push-pull start time off lead-out end) was 30:30:00, with track pitch of the lead-in region being 1.52 μm, and linear speed (immediately) being 1.2 m/s. On the other hand, track pitch of the program region was 1.17 μm, with a linear speed (immediately) of 1.2 m/s, and with track pitch of the lead-out region also similarly being 1.17 μm, and linear speed (immediately) being 1.2 m/s.

Exposing under these conditions the photoresist master disk, the embossed pits were exposed, and after development, sputtering a nickel conductive film, performing nickel electrocasting, separating the nickel plating from the master disk, eliminating photoresist, and performing in sequence washing, surface protective film coating, polishing reverse surface, reverse surface protective film coating, punching out internal diameter, separating the protective film from both surfaces, surface washing, a stamper was prepared. Setting this stamper in an injection molding machine (Sumitomo Electrical machine Manufacturing Co. SD 40 alpha), injection molding was performed, polycarbonate disk substrates were mass produced, and CDs according to an embodiment of the present invention were manufactured on a compact disk manufacturing line (Shinguras Co.).

Evaluation of the playback of these CDs was performed by a CD standard inspection device. The result was that these CDs, in comparison with 23 minute prior art CDs, were made with a longer 7 minute time, recording for 30 minutes (265 MB), with long playing high capacity recording information being attained, and jitter was low, about 20 nsec. Furthermore, pit deviation was within spec, I3 and I11 were both within spec, low Block Error Rate (BLER) was obtained, push-pull signal also had no problems, and tracking was good.

Nevertheless, in the CDs in this embodiment example, productivity at plastic injection molding time could not be within the time according to the prior art; too much time was needed in injection molding.

### EXAMPLE 2

CDs according to this example were manufactured as follows. The stamper of these CDs was 80 mm, with a lead-in region start time being 97:27:00, a program region start time being 00:00:00, and a lead-out region start time (last push-pull start time off lead-out end) being 30:30:00.

With track pitch of the lead-in region being 1.52 μm, linear speed (immediately) was 1.2 m/s, track pitch of the program region was 1.52 μm, linear speed (immediately) was 0.92 m/s, track pitch of the lead-out region was 1.52 μm, and linear speed (immediately) was 0.92 m/s.

After this, CDs according to an embodiment of the present invention were manufactured by the same process as in example 1. These CDs, in comparison with 23 prior art CDs, resulted in a longer 7 minute time, recording for 30 minutes (265 MB), and made long playing high capacity recording information possible to record.

However, because the linear speed was less than 1 m/s, the minimum mark became too small; the jitter, I3, I11, and block error rate were reduced.

### EXAMPLE 3

CDs according to an embodiment of the present invention were manufactured. The size of the CDs is of a card type. Firstly, a stamper according to an embodiment the invention was manufactured.

Lead-in region start time was 97:27:00, a program region start time was 00:00:00, and lead-out region start time (last push-pull start time off lead-out end) was 7:30:00. Track pitch of the lead-in region was 1.52 μm, linear speed (immediately) was 1.2 m/s, track pitch of the program region was 1.22 μm, linear speed (immediately) was 1.2 m/s, track pitch of the lead-out region was 1.20 μm, and linear speed (immediately) was 1.2 m/s.

After this, CDs according to an embodiment of the present invention were manufactured by the same process as in example 1.

Evaluation of the playback of these long playing CDs was performed with a CD standard inspection device (CD-CATS, made by Audio Development Co.). Of these CDs, 2 were compared with 5 prior art limited time CDs, and could record long playing, high capacity information for 7 minutes (65 MB).

Moreover, jitter was low, pit deviation was within specification, I3 and I11 were within specification, low BLER was obtained, the push-pull signal had no problems, and tracking was good. Furthermore, the time required for plastic injection molding was also good, and molding could be performed at the 6 seconds according to the prior art.

### EXAMPLE 4

CDs according to an embodiment of the present invention were manufactured. The size of the CDs were card type. Lead-in region start time was 97:27:00, program region start time was 00:00:00, and lead-out region start time (last push-pull start time off lead-out end) was 10:05:00. Track pitch of the lead-in region was 1.50 μm, linear speed (immediately) was 1.2 m/s, track pitch of the program region was 1.25 μm, linear speed (immediately) was 1.13 m/s, track pitch of the lead-out region was 1.21 μm, and linear speed (immediately) was 1.11 m/s.

After this, long playing CDs according to an embodiment of the invention were manufactured by the same process as in example 1. Evaluation of the playback of these CDs was performed by means of a CD standard inspection device. These CDs were compared with prior art 5 minute limiting time CDs. The long playing time was about twice as long, that is, 10 minutes (100 MB), and they could record and maintain long playing, high capacity recording information. Moreover, jitter was also low, pit deviation was within specification, I3 and I11 were within specification, low BLER was obtained, there were no push-pull signal problems, and tracking was good. Furthermore, the time needed at plastic injection molding time molding was also good, and molding could be performed at 6 seconds similar to the prior art.

Then, by setting the track pitch of the program region between 1.2 and 1.3 μm, and the linear speed between 1.0 and 1.13 m/s, with the respective signal characteristics in a good state, it was possible to attain a recording capacity increased even 2-fold over the prior art CD cards.

### EXAMPLE 5

CDs according to an embodiment of the present invention were manufactured. The CD size was 80 mm. Lead-in region start time was 97:18:00, program region start time was 00:00:00, lead-out region start time (last push-pull start time off lead-out end) was 34:02:00, track pitch of the lead-in region was 1.50 μm, linear speed (immediately) was 1.11 m/s, track pitch of the program region was 1.23 μm, linear speed (immediately) was 1.11 m/s, track pitch of the lead-out region was 1.23 μm, and linear speed (immediately) was 1.11 m/s.

After this, long playing CDs according to an in the invention were manufactured by the same process as in example 1. Evaluation of the playback of these long playing CDs was performed with a CD standard inspection device (CD-CATS, made by Audio Development).

The result was that, compared with the prior art limiting time of 23 minutes, an 11-minute one was extended in playing time to approximately 34 minutes (298 MB), and in spite of its long playing, high capacity recording information, low jitter, with a peak jitter of about 20 nsec, was obtained.

Moreover, the pit deviation was within specifications and furthermore, I3 and I11 were also within specification. Furthermore, low BLER was obtained, there were no problems with the push-pull signal, and tracking was good.

Then, by making the track pitch between 1.2 μm and 1.3 μm, and also making the linear speed between 1.0 m/s and 1.13 m/s, while keeping the respective signal characteristics in a good state, the reduction of productivity was suppressed, and 80-mm CDs with 34 minute or higher recording capacity could be attained.

### EXAMPLE 6

CDs according to an embodiment of the present invention were manufactured. The size of the CDs was 80 mm. Lead-in region start time was 97:27:00, program region start time was 00:00:00, and lead-out region start time was 34:07:00. Track pitch of the lead-in region was 1.50 μm, linear speed (immediately) was 1.16 m/s, track pitch of the program region was 1.18 μm, linear speed (immediately) was 1.16 m/s, track pitch of the lead-out region 1.18 μm was, and linear speed (immediately) was 1.16 m/s.

After this, long playing CDs according to an embodiment the invention were manufactured by the same process as in example 1. Evaluation of the playback of these long playing CDs was performed with a CD standard inspection device (CD-CATS, made by Audio Development). The result was that these CDs, in comparison with 23 minute prior art CDs, were made with an 11 minute longer time, recording for 34 minutes (298 MB), and long playing high capacity recording information was attained, jitter was low, about 18 nsec. Furthermore, pit deviation was within spec, and in addition, I3 and I11 were within specification, low BLER was obtained, push-pull signal also showed no problems, and tracking was good.

However, because the track pitch was less than 1.2 μm, the productivity of the plastic injection molding was reduced.

### EXAMPLE 7

CDs according to an embodiment of the present invention were manufactured. The size of the CDs was 80 mm. Lead-in region start time was 97:18:15, program region start time was 00:00:00, lead-out region start time was 34:02:00. Track pitch of the lead-in region was 1.35 μm, linear speed (immediately) was 1.13 m/s, track pitch of the program region was 1.25 μm, linear speed (immediately) was 1.13 m/s, track pitch of the lead-out region was 1.25 μm, and linear speed (immediately) was 1.13 m/s.

After this, long playing CDs according to an embodiment the invention were manufactured by the same process as in example 1. Evaluation of the playback of these long playing CDs was performed with a CD standard inspection device (CD-CATS, made by Audio Development). The result was that these CDs, in comparison with 23 minute prior art CDs, were made with an 11 minute longer time, recording for 34 minutes (298 MB), and long playing high capacity recording information was attained, jitter was low, about 18 nsec. Furthermore, pit deviation was within spec, and in addition, I3 and I11 were within specification, low BLER was obtained, push-pull signal also showed no problems, and tracking was good.

Moreover, in a playback device in which tracking by a three-beam method was adopted, there were times when tracking was insufficient, but in a playback device in which tracking by means of one beam was adopted, tracking was accurately performed.

### EXAMPLE 8

CDs according to an embodiment of the present invention were manufactured. The size of the CDs was 80 mm. Lead-in region start time was 97:18:15, program region start time was 00:00:00, lead-out region start time was 34:02:00. Track pitch of the lead-in region was 1.52 μm, linear speed (immediately) was 1.11 m/s, track pitch of the program region was 1.24 μm, linear speed (immediately) was 1.11 m/s, track pitch of the lead-out region was 1.2 μm, and linear speed (immediately) was 0.09 m/s.

After this, long playing CDs according to an embodiment of the invention were manufactured by the same process as in example 1. Evaluation of the playback of these long playing CDs was performed with a CD standard inspection device (CD-CATS, made by Audio Development Co.). The result was that these CDs, in comparison with 23 minute prior art CDs, were made with an 11 minute longer time, recording for 34 minutes (298 MB), and long playing high capacity recording information was attained, jitter was low, about 18 nsec. Furthermore, pit deviation was within specification, and in addition, I3 and I11 were within specification.

Furthermore, low BLER was obtained, there were no problems with the push-pull signal, and tracking was good. This characteristic was maintained from 1.0 times speed to 1.2 times speed.

Then, in the program region the track pitch was between 1.2 μm and 1.3 μm, and also the linear speed was between 1.0 m/s and 1.13 m/s. Each signal characteristic was thereby in a good state, while the reduction in productivity was suppressed, and an 80 mm CD could be attained with a high recording capacity of 34 minutes or more.

### EXAMPLE 9

CDs according to an embodiment of the present invention were manufactured. The size of the CDs was 80 mm. Lead-in region start time was 97:18:15, program region start time was 00:00:00, and lead-out region start time was 34:02:00. Track pitch of the lead-in region was 1.48 μm, linear speed (immediately) was 1.11 m/s, track pitch of the program region was 1.24 μm, linear speed (immediately) was 1.11 m/s, track pitch of the lead-out region was 1.2 μm, and linear speed (immediately) was 1.11 m/s.

After this, long playing CDs according to an embodiment of the invention were manufactured by the same process as in example 1. Evaluation of the playback of these long playing CDs was performed with a CD standard inspection device (CD-CATS, made by Audio Development). The result was that these CDs, in comparison with 23 minute prior art CDs, were made with an 11 minute longer time, recording for 34 minutes (298 MB), and long playing high capacity recording information was attained, jitter was low, about 18 nsec. Furthermore, pit deviation was within spec, and in addition, I3 and I11 were within specification, low BLER was obtained, push-pull signal also showed no problems, and tracking was good. Moreover, similarly to embodiment example 8, in the program region the track pitch was between 1.2 μm and 1.3 μm, and also the linear speed was between 1.0 m/s and 1.13 m/s. Each signal characteristic was thereby in a good state, while the reduction in productivity was suppressed, and an 80 mm CD could be attained with a high recording capacity of 34 minutes or more.

### EXAMPLE 10

CDs according to an embodiment of the present invention were manufactured. The size of the CDs was 80 mm. Lead-in region start time was 97:18:15, program region start time was 00:00:00, and lead-out region start time was 40:02:00. Track pitch of the lead-in region was 1.3 μm, linear speed (immediately) was 1 m/s, track pitch of the program region was 1.22 μm, linear speed (immediately) was 1 m/s, track pitch of the lead-out region was 1.2 μm, and linear speed (immediately) was 1 m/s.

After this, long playing CDs according to an embodiment of the invention were manufactured by the same process as in example 1. Evaluation of the playback of these long playing CDs was performed with a CD standard inspection device (CD-CATS, made by Audio Development). The result was that these CDs, in comparison with 23 minute prior art CDs, were made with an 11 minute longer time, recording for 40 minutes (350 MB), and long playing high capacity recording information was attained, jitter was low, about 18 nsec. Furthermore, pit deviation was within spec, and in addition, I3 and I11 were within specification, low BLER was obtained, push-pull signal also showed no problems, and tracking was possible.

### EXAMPLE 11

CDs according to an embodiment of the present invention were manufactured. Initially, preparing a precision washed glass master disk of 200 mm diameter and 6 mm thickness, after primer had been coated onto its surface, positive type photoresist (S1818, Shipurei Co.) was spin coated, and it was baked at 100° C. on a hotplate. A master disk with a coating thickness of 180 nm was completed by this process.

Embossed pits are then formed in the coated master disk on a laser cutting machine; this process is the most important point. Firstly, lead-in region start time of 97:00:00 and lead-out region start time (last push-pull start time off lead-out end) of 30:10:00 was set in a mastering generator Da3080 made by Kenwood.

In a region up to 25.00 mm from the exposure start position, laser cutting was carried out, set at a track pitch of 1.60 μm, linear speed of 1.20 m/s, with a diameter between 25.00-25.10 mm, from a track pitch only of 1.60 μm, at a rate of 0.004 μm with respect to a radius direction 1 μm, while reducing per fixed amount, at the time point of radius 25.10 mm, the track pitch was set so as to become 1.20 μm.

The laser cutting was ended at a time point at which a radius position of 39.10 mm was reached.

Then, the master disk was completed by development with inorganic alkali developing solution (Developer, made by Shifurei Co.) and ultrapure water dilution liquid, at a concentration of 20%. Next, after a treatment to provide electrical conductivity was carried out, by means of a nickel electrocasting device made by Technotran Co., separating from the glass master disk, furthermore punched out to a diameter of internal diameter 34 mm, external diameter 138.00 mm, a nickel stamper was completed.

Setting this stamper in an injection molding machine (Sumitomo Electrical machine Manufacturing Co. SD 40 alpha), injection molding was performed, polycarbonate disk substrates were mass produced, and CDs according to an embodiment of the present invention were completed with formation of an reflecting film, etc.

Moreover when these CDs were measured in a CD-CATS device made by Audio Development Co., they satisfied the Orange Book standard and also CDs with long playing recording time could be manufactured.

### EXAMPLE 12

CDs according to an embodiment of the present invention were manufactured by a method similar to example 11, with lead-in start time of 97:00:00, lead-out start time (last push-pull start time off lead-out end) of 30:10:00, set in a mastering generator Da3080 made by Kenwood.

In a region up to 24.95 mm from the exposure start position, laser cutting was carried out, set at a track pitch of 1.60 μm, linear speed of 1.20 m/s, with a diameter between 24.95-25.00 mm, from a track pitch only of 1.60 μm, at a rate of 0.004 μm with respect to a radius direction 1 μm, while reducing per fixed amount, at the time point of radius 25.00 mm, the track pitch was set so as to become 1.20 μm.

Namely, in the configuration of this embodiment, the track pitch of the end of the lead-in region is caused to gradually change in proportion. Then, at the time point of reaching this unchanged diameter position 39.10 mm, laser cutting was ended.

Then, using a method similar to embodiment example 11, measurement of the CD was performed using a CD-CATS device made by Audio Development Co., and was able to satisfy the standard.

### EXAMPLE 13

CDs according to an embodiment of the present invention were manufactured by a method similar to example 11, with lead-in start time of 97:00:00, lead-out start time (last push-pull start time off lead-out end) of 30:10:00, set in a mastering generator Da3080 made by Kenwood.

In a region up to 25.00 mm from the exposure start position, laser cutting was carried out, set at a track pitch of 1.60 μm, linear speed set at 1.20 m/s; with a diameter between 24.9525.00 mm, from a linear speed only of 1.20 m/s, by use of a fixed speed while reducing, laser cutting was carried out; at the time point of radius 25.00 mm, the linear speed was set so as to become 1.00 m/s. Namely, maintaining unchanged the track pitch of the end of the lead-in region, at the time point when a radius position of 39.10 mm is reached, laser cutting ends.

Then, the CDs manufactured by a method similar to example 11, when measurement is performed in a CD-CATS device made by Audio Development Co., they could satisfy the standard. A CD with which long-playing audio recording is possible can be manufactured in the above manner which satisfy the Orange Book standard.

Furthermore, it goes without saying that regions which dispose regions changing in this kind of gradual change of track pitch or linear speed, are not limited to the lead-in region, and can also be formed in the lead-out region and have similar effects.

As described hereinabove, according to the embodiments of the present invention, while using a prior art playback device, it is possible to improve performance, with the playback device being capable of recognizing the medium, thereby providing an optical information recording medium with increased recording capacity.

While this invention has been particularly shown and described with reference to preferred embodiments thereof, it will be understood by those skilled in the art that various changes in form and details may be made therein without departing from the spirit and scope of the invention as defined by the appended claims and their equivalents.

What is claimed is:

1. An optical information recording medium, having information recorded along a track going from an inner circumference to an outer circumference, a lead-in region, a program region, and a lead-out region, comprising:
a track pitch of the lead-out region being narrower than a track pitch of the lead-in region the program region.

2. The optical information recording medium of claim 1, wherein the track pitch of the program region is between 1.2 μm and 1.3 μm.

3. The optical information recording medium of claim 2, wherein an amount of eccentricity of each track of the optical information recording medium is 30 μm or less.

4. The optical information recording medium of claim 1, wherein a linear speed of the program region is 1.0 m/s or more.

5. The optical information recording medium of claim 2, wherein a linear speed of the program region is 1.0 m/s or more.

6. The optical information recording medium of claim 3, wherein a linear speed of the program region is 1.0 m/s or more.

7. An optical information recording medium, having information recorded along a track going from an inner circumference to an outer circumference, a lead-in region, a program region, and a lead-out region, comprising:
a linear speed of the lead-out region being made slower than a linear speed of the lead-in region and the program region.

8. The optical information recording medium of claim 7, wherein a track pitch of the lead-out region is made narrower than a track pitch of the program region.

9. The optical information recording medium of claim 8, wherein a track pitch of the program region is between 1.2 μm and 1.3 μm.

10. The optical information recording medium of claim 8, wherein an amount of eccentricity of each track of the optical information recording medium is 30 μm or less.

11. The optical information recording medium of claim 9, wherein an amount of eccentricity of each track of the optical information recording medium is 30 μm or less.

12. The optical information recording medium of claim 7, wherein a linear speed of the program region is 1.0 m/s or more.

13. The optical information recording medium of claim 8, wherein a linear speed of the program region is 1.0 m/s or more.

14. The optical information recording medium of claim 9, wherein a linear speed of the program region is 1.0 m/s or more.

15. The optical information recording medium of claim 1, wherein a diameter of the optical information recording medium is 80 mm, and a maximum recording time is between 30 minutes and 40 minutes.

16. The optical information recording medium of claim 2, wherein a diameter of the optical information recording medium is 80 mm, and a maximum recording time is between 30 minutes and 40 minutes.

17. The optical information recording medium of claim 3, wherein a diameter of the optical information recording medium is 80 mm, and a maximum recording time is between 30 minutes and 40 minutes.

18. The optical information recording medium of claim 7, wherein a diameter of the optical information recording medium is 80 mm, and a maximum recording time is between 30 minutes and 40 minutes.

19. The optical information recording medium of claim 8, wherein a diameter of the optical information recording medium is 80 mm, and a maximum recording time is between 30 minutes and 40 minutes.

20. The optical information recording medium of claim 9, wherein a diameter of the optical information recording medium is 80 mm, and a maximum recording time is between 30 minutes and 40 minutes.

21. An optical information recording medium, having information recorded along a track going from an inner circumference to an outer circumference, a lead-in region, a program region, and a lead-out region, comprising:
a track pitch of the program region being made less than 1.3 μm; and
a linear speed of the program region being made between 1.0 m/s and 1.13 m/s.

22. The optical information recording medium of claim 21, wherein the track pitch of the program region is 1.2 μm.

23. An optical information recording medium, having information recorded along a track going from an inner circumference to an outer circumference, a lead-in region, a program region, and a lead-out region, comprising:
a track pitch of the program region being made narrowed in comparison with a track pitch of the lead-in region.

24. An optical information recording medium, having information recorded along a track going from an inner circumference to an outer circumference, a lead-in region, a program region, and a lead-out region, comprising:
a linear speed of the program region being made slowed in comparison with a linear speed of the said lead-in region.

25. A stamper, comprising:
concavities corresponding to convexities, with the convexities corresponding to the concavities, formed in the optical information recording medium of claim 1.

26. A stamper, comprising:
concavities corresponding to convexities, with the convexities corresponding to the concavities, formed in the optical information recording medium of claim 2.

27. A stamper, comprising:
concavities corresponding to convexities, with the convexities corresponding to the concavities, formed in the optical information recording medium of claim 4.

28. A stamper, comprising:
concavities corresponding to convexities, with the convexities corresponding to the concavities, formed in the optical information recording medium of claim 7.

29. A stamper, comprising:
concavities corresponding to convexities, with the convexities corresponding to the concavities, formed in the optical information recording medium of claim 8.

30. A stamper, comprising:
concavities corresponding to convexities, with the convexities corresponding to the concavities, formed in the optical information recording medium of claim 9.

31. A stamper, comprising:
concavities corresponding to convexities, with the convexities corresponding to the concavities, formed in the optical information recording medium of claim 12.

32. A stamper, comprising:
concavities corresponding to convexities, with the convexities corresponding to the concavities, formed in the optical information recording medium of claim 15.

33. A stamper, comprising:
concavities corresponding to convexities, with the convexities corresponding to the concavities, formed in the optical information recording medium of claim 21.

34. A stamper, comprising:
concavities corresponding to convexities, with the convexities corresponding to the concavities, formed in the optical information recording medium of claim 23.

35. A stamper, comprising:
concavities corresponding to convexities, with the convexities corresponding to the concavities, formed in the optical information recording medium of claim 24.

36. The stamper of claim 25, wherein the eccentricity of the concavities or convexities is 10 μm or less.

37. The stamper of claim 28, wherein the eccentricity of the concavities or convexities is 10 μm or less.

38. The stamper of claim 33, wherein the eccentricity of the concavities or convexities is 10 μm or less.

39. The stamper of claim 34, wherein the eccentricity of the concavities or convexities is 10 μm or less.

40. The stamper of claim 35, wherein the eccentricity of the concavities or convexities is 10 μm or less.

41. A manufacturing method, comprising:
providing a first molding die made of metal;
molding from the first molding die a second molding die made of resin; and
molding from the second molding die a stamper, according to one of claims 25-40, made of metal which is a third molding die.
